(19) United States
(12) Patent Application Publication
(10) Pub. No.: US 2012/0044511 A1
(43) Pub. Date: Feb. 23, 2012

(54) TRANSFER APPARATUS FOR OFFSET PRINTING

(76) Inventors: Hiroshi Saito, Yokohama-shi (JP); Hiroaki Imaizumi, Kawasaki-shi (JP)

(21) Appl. No.: 13/266,612

(22) PCT Filed: May 26, 2010
(86) PCT No.: PCT/JP2010/003539

§ 371 Date: Oct. 27, 2011

(30) Foreign Application Priority Data
May 26, 2009 (JP) 2009-126035

(51) Int. Cl. G06K 15/02

(52) U.S. Cl. 358/1.9

(57) ABSTRACT

The present invention relates to a transfer apparatus for offset printing, in which a gate-shaped frame (21) is provided so as to cross over guide rails (13) provided on a mount (12). Left and right bearing housings (28a, 28b) for rotatably holding rotary shafts (30) of a blanket roller (19) in a roller support frame (27) are attached to columns (23a, 23b, 23c, 23d) of the frame (21) via vertical linear movement guides. Furthermore, each nut member (36) of each ball screw mechanism (33) is attached to each of the bearing housings (28a, 28b) to form a transfer apparatus for offset printing (18). When a blanket roller (19) is pressed from above against a plate (14) on a plate table (15) traveling along the guide rails (13) or a print target (16) on a print target table (17) traveling along the guide rails (13) with a predetermined contact pressure, deformation of a mechanical structure portion other than the blanket roller (19) is suppressed by a reactive force to the contact pressure.

### TECHNICAL FIELD

The present invention relates to a transfer apparatus for offset printing provided with a blanket roller that is used, when offset printing is performed, for re-transferring (printing) ink, which has been transferred (received) from a plate, to a print target.

Priority is claimed on Japanese Patent Application No. 2009-126035, filed on May 26, 2009, the content of which is incorporated herein by reference.

### BACKGROUND ART

In recent years, as a technique of forming an electrode pattern (conduction pattern) for liquid crystal displays or the like on predetermined substrates, there are proposed printing techniques of using a conductive paste as printing ink, instead of fine machining by etching a metal vapor-deposited film or the like. For example, there is proposed a method of forming an electrode pattern on a substrate by use of the intaglio plate offset printing technique (for example, see Patent Document 1 and Patent Document 2).

In the case of offset-printing a fine print pattern such as the aforementioned electrode pattern onto a print target such as the aforementioned substrate, high printing accuracy is required. Therefore, as for an offset printing apparatus for performing offset printing with high accuracy, a surface printing apparatus is assumed to be advantageous in which a flat-table-like plate similar to the print target is used as a plate.

FIG. 7 shows a conventionally-proposed offset printing apparatus using a flat-table-like plate. On a base 1, there are provided linear guide rails 2. In parallel with the linear guide rails 2, there is provided a ball screw mechanism 3 that is driven by a servo motor 4. Thereby, it is possible to attach a moving table 7, on which a flat-table-like plate (master plate) 5 and a print target (workpiece plate) 6 are allowed to be fixed with a predetermined distance spaced from each other, slidably to the linear guide rails 2. It is also possible to reciprocate the moving table 7 by the ball screw mechanism 3.

Furthermore, at a predetermined site of the base 1, there is provided a transfer apparatus 8 with a blanket roller 9. The transfer apparatus 8 includes: a pair of left and right support posts (columns) 10 with a predetermined height that are attached respectively to the left and right sides of the base 1; a blanket roller 9 (not shown in the figure) arranged a predetermined distance above the linear guide rails 2 in a direction orthogonal to the longitudinal direction of the linear guide rails 2, both ends of the blanket roller 9 being rotatably supported by bearings each contained in each support post 10; and a drive motor (servo motor) 11 coupled to one end of the blanket roller 9 in a direction of its center of axle.

According to the aforementioned offset printing apparatus, the blanket roller 9 is rotated in the transfer apparatus 8 by the operation of the drive motor 11. In this condition, while the moving table 7 holding a plate 5 and a print target 6 is moved beneath the blanket roller 9 in rotation at a speed in synchronicity with the peripheral velocity of the blanket roller 9, the blanket roller 9 is brought into contact sequentially with the plate 5 and the print target 6. Thus, transfer (reception) from the plate 5 to the blanket roller 9 and then re-transfer (print) from the blanket roller 9 to the print target 6, namely, offset printing can be performed (for example, see Patent Document 3 and Patent Document 4).

### PRIOR ART DOCUMENT

### Patent Document

Patent Document 1: Japanese Patent No. 2797567
Patent Document 2: Japanese Patent No. 3904433
Patent Document 3: Japanese Unexamined Patent Application, First Publication No. H06-15809
Patent Document 4: Japanese Unexamined Patent Application, First Publication No. H09-70948

### SUMMARY OF THE INVENTION

### Problems to be Solved by the Present Invention

In the process of performing offset printing by use of an offset printing apparatus as shown in FIG. 7, it is required that the blanket roller 9 and the plate 5 be pressed against each other with a predetermined contact pressure when transfer (reception) from the plate 5 to the blanket roller 9 is performed. It is also required that the blanket roller 9 and the print target 6 be pressed against each other with a predetermined contact pressure when re-transfer (print) from the blanket roller 9 to the print target 6 is performed. Accordingly, at the time of roller pressurization by the blanket roller 9, a reactive force to the predetermined contact pressure when the blanket roller 9 is pressed against the plate 5 or the print target 6 acts on the blanket roller 9. Therefore, a reactive force to the contact pressure acts on the blanket roller 9. As a result, in the mechanical structure portion of the transfer apparatus 8, deformation is produced such as deflection of the support posts 10 that support the blanket roller 9. Due to the deformation of the mechanical structure portion of the transfer apparatus 8, there is a decrease in geometrical repeatability of the shape, size, position, and the like of the print pattern to be printed from the plate 5 onto the print target 6 via the blanket roller 9, leading to a problem of deterioration in printing accuracy.

The offset printing apparatuses disclosed in Patent Document 3 and Patent Document 4 do not particularly take into consideration the problem of deterioration in printing accuracy due to the aforementioned deformation of the mechanical structure portion of the transfer apparatus 8 at the time of roller pressurization. Therefore, it is not possible to significantly increase the repeatability of the print pattern, leading to a problem of difficulty in printing with higher accuracy.

The present invention provides a transfer apparatus for offset printing capable of suppressing deformation of the mechanical structure portion at the time of roller pressurization by the blanket roller, capable of further increasing the geographical repeatability of the print pattern to be printed from the plate to the print target via the blanket roller, and capable of performing printing with higher accuracy than in the conventional art.

### Means for Solving the Problems

A transfer apparatus for offset printing according to the present invention has a construction in which a gate-shaped frame is provided so as to cross over a common moving table or separate moving tables, for holding a plate and a print target, which travel along guides provided on a mount, the gate-shaped frame being made by integrally coupling top ends of columns vertically extending a predetermined distance. Furthermore, a blanket roller, which is rotationally-drivably supported, is attached raisably/lowerably to the gate-shaped frame, and also a raising-lowering actuator for the blanket roller is provided on the gate-shaped frame. As a result, by the raising-lowering actuator, the blanket roller is made capable of being raised/lowered from a height position at which a lowest end of an outer circumferential surface of the blanket roller is a predetermined distance above a surface level of the plate and the print target held on the common moving table or the separate moving tables to a lowered position at which the lowest end is beneath the surface level of the plate and the print target. Furthermore, the blanket roller is made capable of being pressed from above against surfaces of the plate and the print target held on the common moving table or the separate moving tables.

In the above construction, both ends of the blanket roller, which extends in a left-right direction orthogonal to a longitudinal direction of the guides provided on the mount, are rotatably held in left and right bearing housings of a roller support frame. In addition, the left and right bearing housings of the roller support frame are raisably/lowerably attached to the gate-shaped frame via vertical linear movement guides, and the raising-lowering actuator is attached to each of the left and right bearing housings of the roller support frame. Therefore, it is possible to raise/lower the blanket roller together with the roller support frame by use of the raising-lowering actuators.

In the above construction, the raising-lowering actuators comprise two ball screw mechanisms each of which comprises: a drive motor exposed to an upper portion of the gate-shaped frame; a vertical thread shaft coupled to the drive motor via a gear box; and a nut member threaded to the thread shaft. Furthermore, the nut members of the ball screw mechanisms are attached individually to the left and right bearing housings of the roller support frame.

### Effect of the Present Invention

With the transfer apparatus for offset printing according to the present invention, excellent advantageous effects as follows are obtained.

(1) It is constructed such that a gate-shaped frame is provided so as to cross over a common moving table or separate moving tables, for holding a plate and a print target, which travel along guides provided on a mount, the gate-shaped frame being made by integrally coupling top ends of columns vertically extending a predetermined distance. Furthermore, a blanket roller, which is rotationally-drivably supported, is attached raisably/lowerably to the gate-shaped frame, and also a raising-lowering actuator for the blanket roller is provided on the gate-shaped frame. As a result, by the raising-lowering actuator, the blanket roller is made capable of being raised/lowered from a height position at which a lowest end of an outer circumferential surface of the blanket roller is a predetermined distance above a surface level of the plate and the print target held on the common moving table or the separate moving tables to a lowered position at which the lowest end is beneath the surface level of the plate and the print target. Furthermore, the blanket roller is made capable of being pressed from above against surfaces of the plate and the print target held on the common moving table or the separate moving tables. Therefore, with the blanket roller being pressed from above against the plate or the print target held on the common moving table or the separate moving tables with a predetermined contact pressure to thereby perform transfer (reception) or re-transfer (print), a reactive force to the predetermined contact pressure acts upwardly on the blanket roller. Even if the reactive force to the predetermined contact pressure is input to the gate-shaped frame to which the blanket roller is raisably/lowerably attached, it is possible to prevent the possibility that the columns of the frame are deflected in the inward-outward direction, and also to suppress the amount of deformation of the frame. Namely, it is possible to suppress the amount of deformation of the mechanical structure portion other than the blanket roller at the time of the transfer or the re-transfer. Therefore, it is possible to increase the geometrical repeatability of the shape, size, position, and the like of the print pattern.

(2) It is constructed such that both ends of the blanket roller, which extends in a left-right direction orthogonal to a longitudinal direction of the guides provided on the mount, are rotatably held in left and right bearing housings of a roller support frame. In addition, the left and right bearing housings of the roller support frame are raisably/lowerably attached to the gate-shaped frame via vertical linear movement guides, and the raising-lowering actuator is attached to each of the left and right bearing housings of the roller support frame. Thus, it is possible to raise/lower the blanket roller together with the roller support frame by use of the raising-lowering actuators. Therefore, the reactive force, of the predetermined contact pressure against the plate or the print target, acting on the blanket roller can be received from the rotary shafts on both sides of the blanket roller to the corresponding raising-lowering actuators via the corresponding bearing housings. Accordingly, it is possible to suppress the deformation of the roller support frame at the time of transfer (reception) or re-transfer (print). Namely, it is possible to further suppress the amount of deformation of the mechanical structure portion other than the blanket roller, and to further increase the geometrical repeatability of the print pattern.

(3) The raising-lowering actuators are made of two ball screw mechanisms each of which includes: a drive motor provided so as to be exposed to an upper portion of the gate-shaped frame; a vertical thread shaft coupled to the drive motor via a gear box; and a nut member threaded to the thread shaft. Furthermore, the nut members of the ball screw mechanisms are attached individually to the left and right bearing housings of the roller support frame. Therefore, the heat generated by the raising-lowering motors of the ball screw mechanisms can be directly released to the atmosphere above, and also the thermal deformation of the frame caused by the influence of the heat generated by the raising-lowering motors can be suppressed. Consequently, it is possible to further suppress the amount of deformation of the mechanical structure portion other than the blanket roller at the time of transfer (reception) or re-transfer (print), and hence, it is possible to further increase the geometrical repeatability of the print pattern.

(4) With the suppression of geometrical displacement of the print pattern as described above in (1), (2), and (3), it is possible to perform printing with higher accuracy than in the conventional art.

### BRIEF DESCRIPTION OF THE DRAWINGS

FIG. 1 is a schematic front view showing an embodiment of a transfer apparatus for offset printing according to the present invention.

FIG. 2 is a schematic front cutaway view of the transfer apparatus of FIG. 1.

FIG. 3 is a cross-sectional view of FIG. 1 taken along the A-A arrow.

FIG. 4 is a cross-sectional view of FIG. 1 taken along the B-B arrow.

FIG. 5 is a schematic side view showing a general construction of a transfer apparatus for offset printing provided with the transfer apparatus of FIG. 1.

FIG. 6 is an enlarged view of a bottom portion functioning as a bed for the transfer apparatus of FIG. 1 in a mount of the transfer apparatus for offset printing of FIG. 5.

FIG. 7 is a schematic diagram showing an example of a conventionally-proposed transfer apparatus for offset printing that uses a flat-shaped plate.

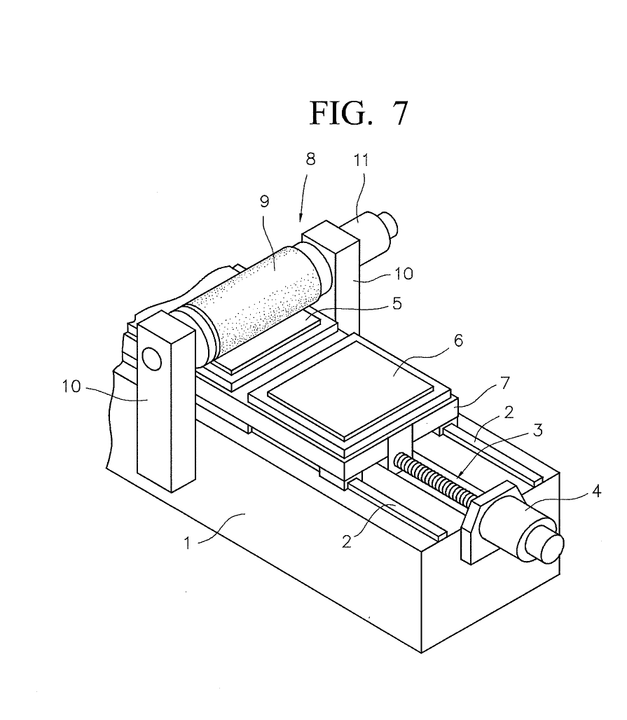

### MODE FOR CARRYING OUT THE INVENTION

Hereunder is a description of a mode for carrying out the present invention with reference to the drawings.

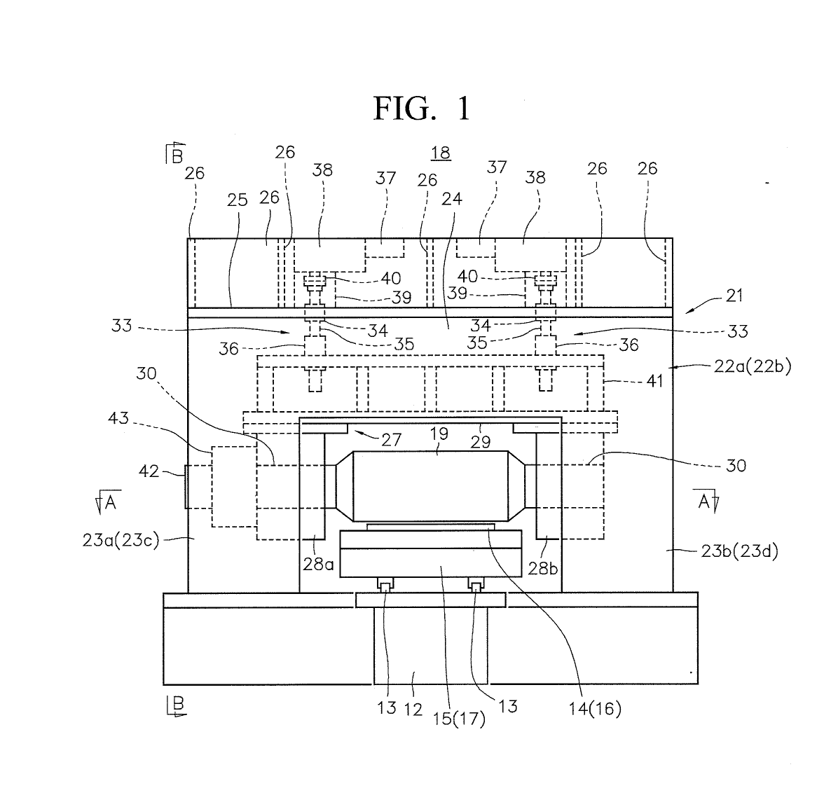

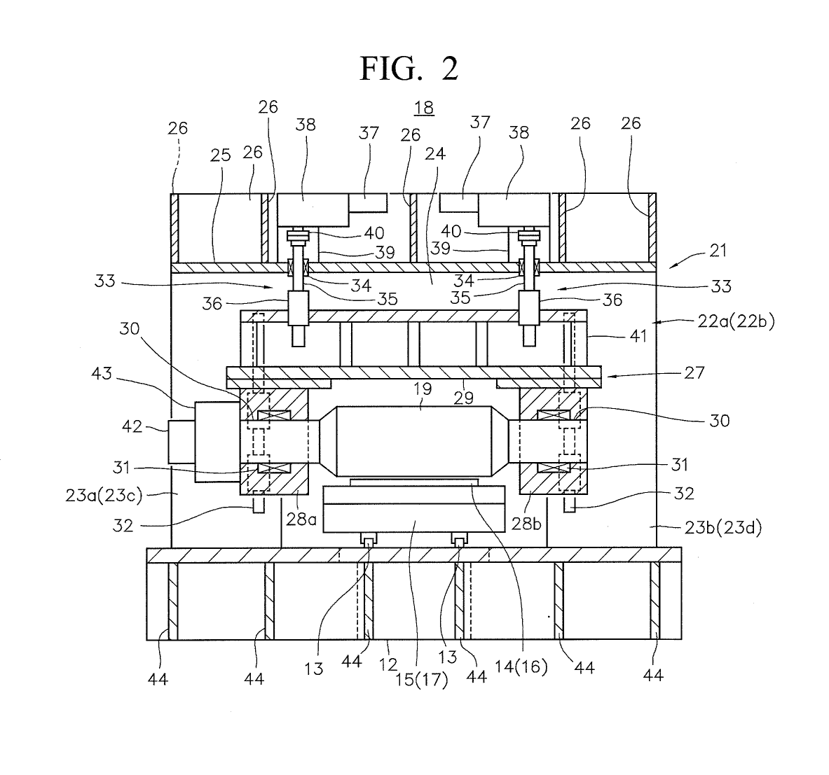

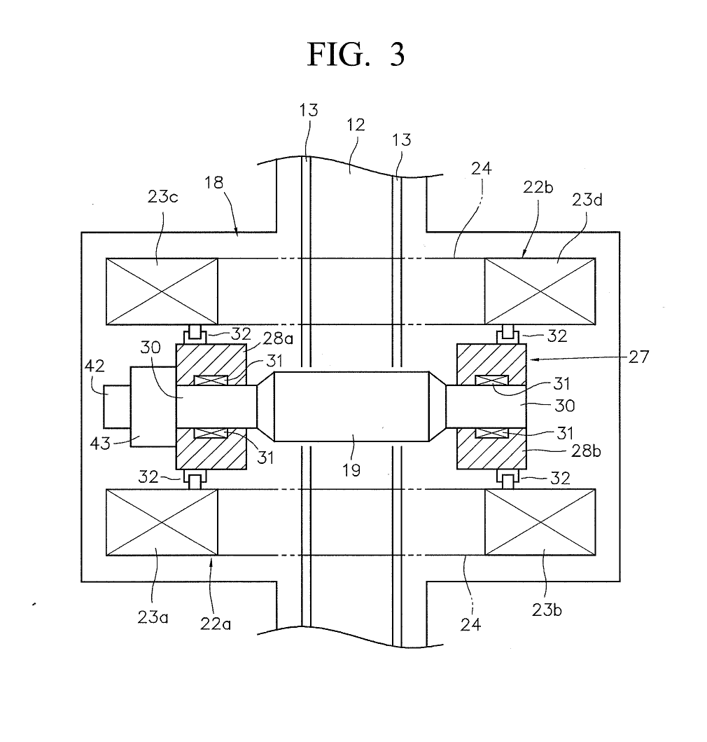

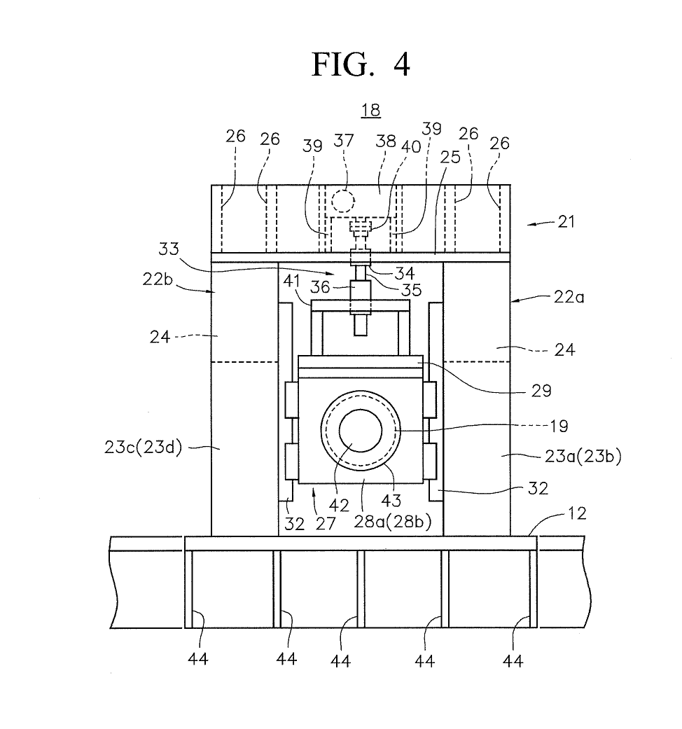

FIG. 1 to FIG. 6 show an embodiment of a transfer apparatus for offset printing according to the present invention.

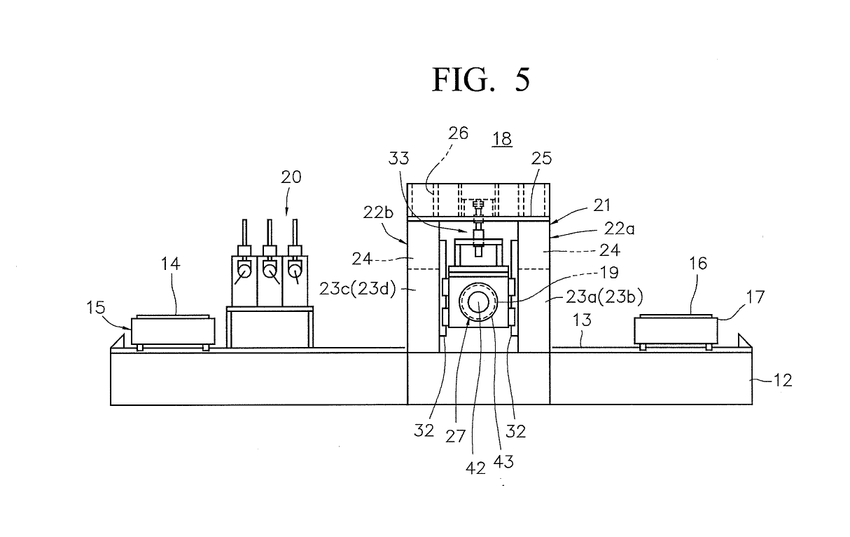

In the transfer apparatus for offset printing shown in FIG. 5, guide rails 13, for example a pair of guide rails 13, which extend in one direction, are provided on an upper side of a horizontal mount 12. To the guide rails 13, a plate table 15 and a print target table 17 are attached so as to be independently reciprocated (traveled) by individual drive devices (not shown in the figure). The plate table 15 and the print target table 17 are moving tables for respectively holding, for example, a flat-table-like plate 14 and a flat-table-like print target 16 such as a substrate.

Furthermore, at a position somewhere in the longitudinal direction of the guide rails 13 where both of the plate table 15 and the print target table 17 can travel (for example, at a predetermined site on the mount 12 corresponding to an intermediate position in the longitudinal direction of the guide rails 13), there is provided a transfer apparatus for offset printing 18 of the present invention, which is provided with a blanket roller 19 (hereinafter, referred to as a transfer apparatus 18 of the present invention). In addition, at another position somewhere in the longitudinal direction of the guide rails 13 where the plate table 15 can travel (for example, at a predetermined site on the mount 12 spaced a predetermined distance from the installation site of the transfer apparatus 18 of the present invention to first ends in the longitudinal direction of the guide rails 13), there is provided an inking device 20 for inking the plate 14 held on the plate table 15.

The transfer apparatus 18 of the present invention used as the transfer apparatus for offset printing has a construction as shown in FIG. 1 to FIG. 4.

Namely, top ends of a pair of left and right columns 23a and 23b and top ends of a pair of left and right columns 23c and 23d which have a predetermined dimension in an up-down direction are integrally connected respectively by a beam member 24 horizontally extending in a predetermined distance, to thereby form two gate-shaped frame members 22a, 22b. Furthermore, the two gate-shaped frame members 22a, 22b are arranged in parallel in a forward-backward direction with a predetermined distance spaced from each other. In addition, summit portions of the gate-shaped frame members 22a, 22b are integrally connected by a top board member 25, which has a rectangular plate shape and has its predetermined sites reinforced by ribs 26, to thereby form a gate-shaped frame 21. Furthermore, in the frame 21, the beam members 24 of the gate-shaped frame members 22a, 22b are arranged at predetermined sites on the mount 12 so as to cross over (pass over) the guide rails 13 in a direction orthogonal to the longitudinal direction of the guide rails 13, and lower ends of the columns 21a, 21b, 21c, and 21d are fixed to the mount 12. Accordingly, with the transfer apparatus 18 being formed in a gate-shaped structure in which the top ends of the left and right columns 23a and 23b fixed to the mount 12 and the top ends of the columns 23c and 23d fixed to the mount 12 are integrally connected by the respective beam members 24, the columns 23a, 23b and the columns 23c, 23d arranged on the left and right sides are made highly rigid, making it possible to prevent the columns 23a, 23b, 23c, and 23d from being deflected in the inward-outward direction (left-right direction).

A pair of left and right bearing housings 28a, 28b spaced a predetermined distance from each other are integrally connected by a coupling member 29 extending in the left-right direction, to thereby form a roller support frame 27. Furthermore, rotary shafts 30 each provided on each side of the blanket roller 19 are rotatably held respectively in left and right bearing housings 28a, 28b of the roller support frame 27 via a bearing 31. In addition, the left and right bearing housings 28a and 28b of the roller support frame 27 are attached respectively between the columns 23a and 23c and between the columns 23b and 23d so as to be vertically slidable via their corresponding linear movement guides 32 extending vertically. The pairs of columns are arranged respectively on the left and right sides of the frame 21 in the forward-backward direction (in the longitudinal direction of the guide rails 13).

At each of the left and right sites, in the top board member 25 of the frame 21, above the bearing housings 28a, 28b of the roller support frame 27, there is provided a bearing 34 in a penetrating manner. In each bearing 34, a thread shaft 35, which vertically extends in a predetermined length, is rotatably held at a part close to its upper end. At this time, as will be described later, a load acting on each thread shaft 35 can be supported by receiving the load from each bearing 34 to the top board member 25 by means of the roller support frame 27 attached to lower portions of the thread shafts 35 via their corresponding nut members 36.

On an upper side of the top board member 25 in the vicinity of each bearing 34, there is installed a gear box 38, which is connected to a raising-lowering motor 37 such as a servo motor, via a predetermined support member 39. Furthermore, to an output side of the gear box 38, there is coupled via a coupling 40 an end of a protrusion portion of the thread shaft 35 that protrudes to an upper side of the bearing 34.

Each nut member 36, which is threaded onto each thread shaft 35, is attached to an upper portion of each of the bearing housings 28a, 28b of the roller support frame 27 via a predetermined attachment member 41. Thus, ball screw mechanisms 33 as raising-lowering actuators are formed, each of which is made of: the raising-lowering motor 37; the thread shaft 35 rotationally driven through the operation of the raising-lowering motor 37 via the gear box 38; and the nut member 36. As a result, through the rotational drive of the thread shafts 35 via the gear boxes 38 in accordance with the operations of the raising-lowering motors 37 of the ball screw mechanisms 33, the roller support frame 27 holding the blanket roller 19 can be raised/lowered integrally with the nut members 36. With the raising/lowering of the roller support frame 27 by the ball screw mechanisms 33, the blanket roller 19 can be raised/lowered in the range from a height position at which the lowest end of an outer circumferential surface of the blanket roller 19 is a predetermined distance above the upper surfaces of the plate 14 held on the plate table 15 and the print target 16 held on the print target table 17 to a height position at which the lowest end of the outer circumferential surface of the blanket roller 19 is a slight distance beneath the surfaces of the plate 14 held on the plate table 15 and the print target 16 held on the print target table 17.

To the external side of the bearing housing 28a of the roller support frame 27, there is attached a decelerator 43, which is connected to a rotational drive motor 42. In addition, to an output shaft (not shown in the figure) of the decelerator 43, the rotary shaft 30 of the blanket roller 19 held in the bearing housing 28a is coupled. As a result, through the operation of the rotational drive motor 42, it is possible to rotationally drive the blanket roller 19 at a predetermined rotational velocity via the decelerator 43.

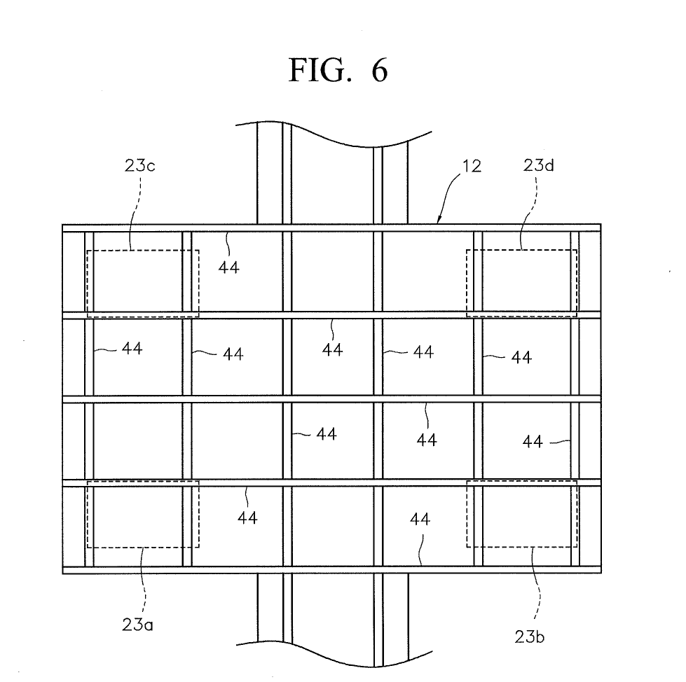

As shown in FIG. 6, in the mount 12 of the transfer apparatus for offset printing used in the transfer apparatus 18 of the present invention, a multitude of ribs 44 are internally attached in a grid pattern to the mount 12 in the portion functioning as a bed for the transfer apparatus 18 of the present invention, namely, in the region corresponding to the installation sites of the columns 23a, 23b, 23c, and 23d of the frame 21 and the inside area surrounded thereby. This is to increase the rigidity of the portion functioning as a bed. Therefore, in the transfer apparatus 18 of the present invention, when the blanket roller 19 is brought into contact from above with the plate 14 or the print target 16 with a predetermined contact pressure at the time of performing transfer from the plate 14 to the blanket roller 19 or re-transfer from the blanket roller 19 to the print target 16, it is possible prevent a positional displacement between the blanket roller 19 held in the frame 21 and the plate 14 held on the plate table 15 or the print target 16 held on the print target table 17 resulting from the deformation by deflection of the portion functioning as a bed in the mount 12 of the transfer apparatus 18 of the present invention, even if a load from the contact pressure acts downwardly on a portion on which the plate table 15 holding the plate 14 or the print target table 17 holding the print target 16 is arranged in the mount 12 or even if a load from a reactive force of the contact pressure acts upwardly on the installation sites of the columns 23a, 23b, 23c, and 23d of the frame 21 in the mount 12.

In the case of using the transfer apparatus 18, the plate table 15 holding the plate 14 is sent to the inking device 20 and subjects the plate 14 to inking in advance.

Furthermore, through the operations of the raising-lowering motors 37 of the ball screw mechanisms 33 in the transfer apparatus 18 of the present invention, the blanket roller 19 is raised integrally with the roller support frame 27, to thereby withdraw the blanket roller 19 to a position at which the lowest end of the outer circumference of the blanket roller 19 is the predetermined distance above the upper surfaces of the plate 14 held on the plate table 15 and the print target 16 held on the print target table 17. In this condition, the plate table 15 holding the inked plate 14 and the print target table 17 holding the print target 16 are moved to positions that correspond to those on an upstream side in the moving direction of the lowest end of the outer circumference of the blanket roller 19 when the blanket roller 19 is rotated for transfer or re-transfer.

In this condition, the blanket roller 19 is rotated through the operation of the rotational drive motor 42. At the same time, the plate table 15 holding the plate 14 starts to move at the velocity in synchronicity with the peripheral velocity of the blanket roller 19 in rotation. When the plate 14 held on the plate table 15 arrives beneath the blanket roller 19, the blanket roller 19 is lowered integrally with the roller support frame 27 through the operations of the raising-lowering motors 37 of the ball screw mechanisms 33, and is then caused to be rotated while being pressed against the plate 14 with a predetermined contact pressure. Thereby, transfer (reception) of ink is performed from the inked plate 14 to the blanket roller 19.

After completion of the transfer, the blanket roller 19 is temporarily withdrawn integrally with the roller support frame 27 through the operation of the raising-lowering motors 37 of the ball screw mechanisms 33 so that the lowest end of the outer circumferential surface of the blanket roller 19 is at a height position which is a predetermined distance above the upper surface of the print target 16 held on the print target table 17.

After that, similarly to the case of the transfer, the print target table 17 holding the print target 16 starts to be moved, from the same direction as that for the plate table 15 at the time of the transfer, at a velocity in synchronicity with the peripheral velocity of the blanket roller 19 that is rotated through the operation of the rotational drive motor 42. When the print target 16 held on the print target table 17 arrives beneath the blanket roller 19, the blanket roller 19 is lowered integrally with the roller support frame 27 through the operations of the raising-lowering motors 37 of the ball screw mechanisms 33. Then, the blanket roller 19 is rotated while being pressed against the print target 16 with the predetermined contact pressure. Thereby, re-transfer from the blanket roller 19 to the print target 16, that is, offset printing onto the print target 16 is performed.

At the time of transfer (reception) or re-transfer (print) that is performed by pressing the blanket roller 19 from above against the plate 14 held on the plate table 15 or the print target 16 held on the print target table 17 with the predetermined contact pressure, a reactive force to the contact pressure acts upwardly on the blanket roller 19. However, the left and right bearing housings 28a, 28b of the roller support frame 27, in which the rotary shafts 30 on both sides of the blanket roller 19 are individually held, are attached respectively to the columns 23a, 23c and the columns 23b, 23d of the frame 21 via the linear movement guides 32. In addition, to each of the bearing housings 28a, 28b, the nut member 36 of the corresponding ball screw mechanism 33 as a raising-lowering actuator is attached via the attachment member 41. Therefore, the reactive force to the contact pressure acting on the blanket roller 19 is directly transmitted from the rotary shafts 30 on both ends of the blanket roller 19 to the corresponding ball screw mechanisms 33 via the corresponding bearing housings 28a, 28b. Accordingly, it is possible to suppress the amount of deformation of the roller support frame 27 by the reactive force to the contact pressure that acts at the time of transfer (reception) and re-transfer (print).

The ball screw mechanisms 33 to which the reactive force to the contact pressure is input from the blanket roller 19 via the rotary shafts 30 and the bearing housings 28a, 28b, are adapted to be supported by the gate-shaped frame 21. Therefore, when the reactive force to the contact pressure is input from the blanket roller 19 to the ball screw mechanisms 33 via the rotary shafts 30 and the bearing housings 28a, 28b, deformation such as deflection of the columns 23a, 23b, 23c, and 23d of the frame 21 that support the ball screw mechanisms 33 is prevented. Accordingly, it is possible to suppress the amount of deformation of the frame 21 itself.

Furthermore, as shown in FIG. 6, in the mount 12 of the offset printing apparatus, the inside region surrounded by the installation sites of the columns 23a, 23b, 23c, and 23d, the multitude of ribs 44 are provided on the internal surface side of the mount 12 to increase its rigidity. Therefore, it is possible to suppress the amount of deformation of the mount 12 at the base portions of the columns 23a, 23b, 23c, and 23d resulting from the reactive force to the contact pressure, and the amount of deformation of the mount 12 transmitted via the tables 15, 17.

The raising-lowering motors 37 of the ball screw mechanisms 33 are provided above the top board member 25 of the frame 21. This allows the heat from the raising-lowering motors 37 to be directly released to the atmosphere above. Therefore, it is possible to suppress the thermal deformation of the frame 21 due to the influence of the heat generated by the raising-lowering motors 37.

Therefore, according to the transfer apparatus 18 of the offset printing apparatus of the present invention, when the blanket roller 19 is pressed from above against the plate 14 or the print target 16 with the predetermined contact pressure to perform transfer (reception) or re-transfer (print), it is possible to suppress to a minimum the deformation of the mechanical structure portion other than the blanket roller 19 such as the frame 21 and the roller support frame 27, and the deformation of the mechanical structure portion due to the heat generated by the raising-lowering motors 37 for raising/lowering the blanket roller 19.

Namely, when transfer or re-transfer by the blanket roller 19 is performed, it is possible to suppress a relative, positional displacement between the blanket roller 19 and the plate 14 as well as between the blanket roller 19 and the print target 16 resulting from the deformation of the mechanical structure portion. As a result, it is possible to suppress a geometrical displacement of the print pattern such as its shape, size, and position. This makes it possible to perform printing with higher accuracy than conventionally.

The present invention is not limited to the embodiment. From the point of view of suppressing a thermal deformation of the frame 21 due to the heat generated by the raising-lowering motors 37 of the ball screw mechanisms 33 as a drive source for raising/lowering the blanket roller 19, it is desirable that the raising-lowering motors 37 be provided on the upper surface side of the top board member 25 of the frame 21 to allow the heat generated by the raising-lowering motors 37 to be directly released to the atmosphere above. However, if there is a slight possibility that the heat generated by the raising-lowering motors 37 has an influence on the thermal deformation of the frame 21 such as the case where the amount of heat generated by the raising-lowering motors 37 is small, the raising-lowering motors 37 of the ball screw mechanisms 33 may be arranged at sites other than on the upper surface of the top board member 25 of the frame 21.

As raising-lowering actuators, any type of actuators other than the ball screw mechanisms 33 may be used so long as they can be coupled to the bearing housings 28a, 28b of the roller support frame 27 and can raise/lower the blanket roller 19 integrally with the roller support frame 27 in a predetermined height range.

As for the frame 21, a gate-shaped frame 21 may be constructed by directly coupling the summit portions of the columns 23a, 23b, 23c, and 23d with the top board member 25.

So long as the plate 14 and the print target 16 are movable beneath the blanket roller 19, the present invention may be applied to an offset printing apparatus in which the plate 14 and the print target 16 are held on a common moving table that is movable along the guide rails 13.

In the case of improving the volume efficiency, the following construction may be adopted. A plate 14 and a print target 16 are fixedly lined up on the mount. On both sides of the plate 14 and the print target 16, guide rails are provided along the direction in which the plate 14 and the print target 16 are lined up on the mount. A carriage is attached travelably to the guide rails. To the carriage, the lower ends of the columns 23a, 23b, 23c, and 23d in the transfer apparatus 18 of the present invention are attached. Then, the frame 21 raisably/lowerably holding the blanket roller 19 is moved with respect to the plate 14 and print target 16 whose positions are fixed as described above. Furthermore, the offset printing apparatus of the present invention may be applied to performing printing on any print target 16 other than a substrate.

### INDUSTRIAL APPLICABILITY

The present invention provides a transfer apparatus for offset printing capable of suppressing the deformation of the mechanical structure portion at the time of roller pressurization by the blanket roller, capable of increasing the geometrical repeatability of the print pattern to be printed from the plate to the print target via the blanket roller, and capable of performing printing with higher accuracy than conventionally.

### DESCRIPTION OF REFERENCE NUMERALS

12: mount
13: guide rail (guide)
14: plate
15: plate table (moving table)
16: print target
17: print target table (moving table)
19: blanket roller
21: frame
22a, 22b: gate-shaped frame member
23a, 23b, 23c, 23d: column
27: roller support frame
28a, 28b: bearing housing
30: rotary shaft
31: bearing
32 linear movement guide
33: ball screw mechanism (raising-lowering actuator)
35: thread shaft
36: nut member
37: raising-lowering motor
38: gear box

1. A transfer apparatus for offset printing, comprising a construction in which:
a gate-shaped frame is provided so as to cross over a common moving table or separate moving tables, for holding a plate and a print target, which travel along guides provided on a mount, the gate-shaped frame being made by integrally coupling top ends of columns vertically extending a predetermined distance; a blanket roller, which is rotationally-drivably supported, is attached raisably/lowerably to the gate-shaped frame, and also a raising-lowering actuator for the blanket roller is provided on the gate-shaped frame; by the raising-lowering actuator, the blanket roller is made capable of being raised/lowered from a height position at which a lowest end of an outer circumferential surface of the blanket roller is a predetermined distance above a surface level of the plate and the print target held on the common moving table or the separate moving tables to a lowered position at which the lowest end is beneath the surface level of the plate and the print target; and the blanket roller is made capable of being pressed from above against surfaces of the plate and the print target held on the common moving table or the separate moving tables.

2. The transfer apparatus for offset printing according to claim 1, wherein
both ends of the blanket roller, which extends in a left-right direction orthogonal to a longitudinal direction of the guides provided on the mount, are rotatably held in left and right bearing housings of a roller support frame; and the left and right bearing housings of the roller support frame are raisably/lowerably attached to the gate-shaped frame via vertical linear movement guides, and the raising-lowering actuator is attached to each of the left and right bearing housings of the roller support frame, to thereby allow the blanket roller to be raised/lowered together with the roller support frame by use of the raising-lowering actuators.

3. The transfer apparatus for offset printing according to claim 2, wherein
the raising-lowering actuators comprise two ball screw mechanisms each of which comprises: a drive motor exposed to an upper portion of the gate-shaped frame; a vertical thread shaft coupled to the drive motor via a gear box; and a nut member threaded to the thread shaft, and wherein the nut members of the ball screw mechanisms are attached individually to the left and right bearing housings of the roller support frame.
